(19) United States
(12) Patent Application Publication
(10) Pub. No.: US 2013/0032511 A1
(43) Pub. Date: Feb. 7, 2013

(54) APPARATUS AND PROCESSES FOR PRODUCTION OF COAL DERIVED OIL PRODUCTS

(71) Applicant: Geoffrey R. WILSON, Kittanning, PA (US)

(72) Inventor: Geoffrey R. WILSON, Kittanning, PA (US)

(73) Assignee: Coalstar Industries Inc., Johnstown, PA (US)

(21) Appl. No.: 13/402,728

(22) Filed: Feb. 22, 2012

Related U.S. Application Data
(63) Continuation of application No. PCT/US10/46859, filed on Aug. 26, 2010.
(60) Provisional application No. 61/272,171, filed on Aug. 26, 2009.

(51) Int. Cl. C10G 1/04; B01D 11/02

(52) U.S. Cl. 208/428; 196/14.52

(57) ABSTRACT

Apparatus and processes for production of coal derived oils from a mixture of pulverized coal and a coal solvent in predetermined proportions, which when agitated produces a substantially ash-free coal slurry liquid. Subsequently the coal slurry liquid is heat treated in a fractionator to produce predetermined products, and a portion of the resultant coal solvent is recovered and recycled to produce coal derived oils.

### CROSS REFERENCE TO RELATED APPLICATIONS

This application is a continuation of international application number PCT/US 10/046859, filed on Aug. 26, 2010, which claims priority to U.S. provisional patent Appl. Ser. No. 61/272,171, filed Aug. 26, 2009, the entire contents of which are hereby incorporated by reference.

### BACKGROUND OF THE INVENTION

1. Field of the Invention

This invention relates generally to fuels and more particularly to fuels derived from coal for production of coke and activated carbon products.

2. Description of the Related Art

The worldwide demand for energy continues to grow annually with an ever-increasing need to control the energy generation processes to minimize harmful pollution effects of, for example, emissions into the atmosphere of carbon dioxide or mercury and sulfur by-products. In the United States and other industrial nations, there are expanding regulatory efforts to significantly improve energy generation processes to avoid harmful pollution, e.g., heavy metals such as mercury and sulfur gases from coal-based power electric generating stations.

The United States and other industrial nations are faced with increasing pressure to impose tougher limitations on greenhouse gas emissions which again place substantially higher production costs on companies which would be required to pay substantially higher costs on companies and increase the difficulty of obtaining governmental permits.

Targeted emissions may include emissions of heavy metals such as mercury, as well as emissions of carbon dioxide and sulfur oxides. These emissions would be a very serious problem for the large number of power plants in the United States in which steam turbine generators are driven with steam raised by burning coal.

In one example, the Clean Air Mercury Rule mandates a 70% reduction in mercury emissions from all coal-fired power plants by 2010 and 90% reduction by 2018. These restrictions will substantially expand the worldwide market for carbon production and are estimated in many technical publications to exceed 500 million dollars in the US.

### SUMMARY OF THE INVENTION

Coal for many years has been a readily available source of electric energy. However, while coal is the one source of energy for which long term supply contracts have been readily available, governmental regulations are currently seriously considering much stronger restrictions to impose tougher limitations on greenhouse gas emission and thus likely in the future to impose substantially higher costs on the operation of coal-fired power generating facilities by requiring the installation of additional cleaning equipment on the plant gas emissions.

Many industrial power plants are currently exploring improvements for coal fired power plants not only to restrict or substantially reduce the emissions of carbon dioxide gases but also to substantially reduce any emissions of undesirable gases such as mercury and oxides of sulfur.

According to one aspect, one or more embodiments described herein improve the operation of coal fired power plants by substantially reducing objectionable emissions including mercury and sulfur.

According to another aspect, one or more embodiments described herein improve the economic operation of coal-fired power plants by avoiding exhaust conditions exceeding pollution restrictions.

According to another aspect, one or more embodiments described herein economically improve the operation of coal fired electric generation plants.

### BRIEF DESCRIPTION OF THE DRAWINGS

These and other more detailed and specific features of the present invention are more fully disclosed in the following specification, reference being had to the accompanying drawings, in which:

FIG. 1 is a schematic and flow diagram of a low cost, coal-solvent extraction process or apparatus.

FIG. 2 is a schematic and flow diagram of a low cost, energy efficient coal-solvent process or apparatus.

FIG. 3 is a schematic and flow diagram of an apparatus and process for production of activated carbon from coal.

FIG. 4 is a schematic and flow diagram of an apparatus and process for production of coal derived oil.

FIGS. 5A-B are schematic and flow diagrams illustrating integration of activated carbon production with power plant flue gas clean up.

FIG. 6 is a schematic and flow diagram of an apparatus and process for the production of coal derived oils.

### DETAILED DESCRIPTION OF THE INVENTION

In the following description, for purposes of explanation, numerous details are set forth including flow charts and system configurations in order to provide an understanding of one or more embodiments of the present invention. However, it is and will be apparent to one skilled in the art that these details are not required in order to practice the present invention.

According to one aspect, apparatus and processes described herein for the production of coal derived oils are particularly useful in formulating useful coal derived oils for use in numerous subsequent manufacturing processes including cleaner burning fuels and fabricating diverse manufactured products including improved rubber tires and related products.

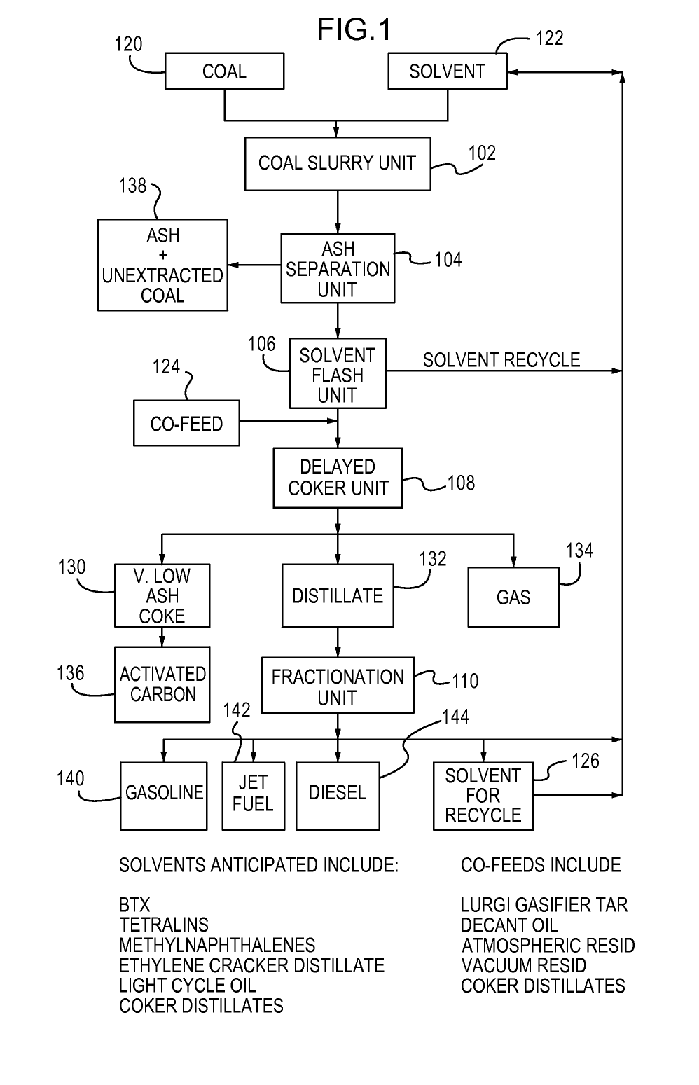

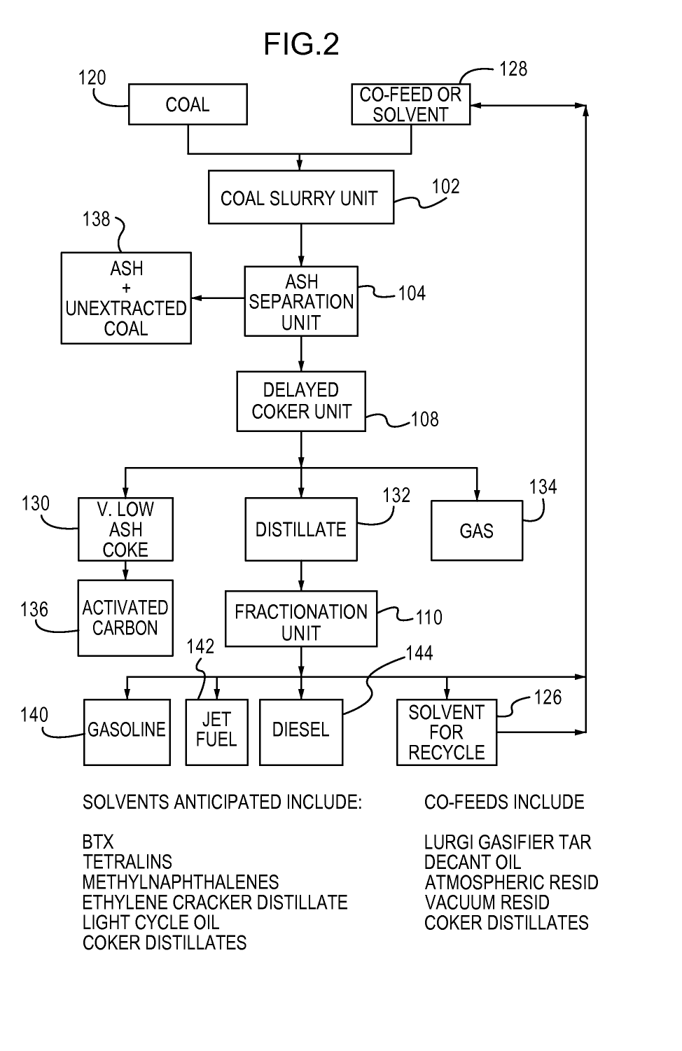

FIGS. 1 and 2 represent two alternative processes and corresponding apparatus for production of Low Ash Coke and/or activated carbon. The apparatus includes a coal slurry unit 102, ash separation unit 104, solvent flash unit 106, delayed coker unit 108, and fractionation unit 110. There are also inputs for coal 120, solvent 122, co-feed 124 and solvent for recycle 126. Also illustrated in the figure are outputs for intermediate products low ash coke 130, distillate 132, gas 134, activated carbon 136, and ash with un-extracted coal 138, as well as end products gasoline 140, jet fuel 142, diesel fuel 144.

Referring first to FIG. 1, after the de-ashing step, a flash step is included to remove oil, suitable for dissolving additional fresh coal, by recycling to the solvent/co-feed tank. Additional recycle co-feed is produced in the final fractionation step. FIG. 2 is identical to FIG. 1 except that the flash step is eliminated and the co-feed (128) is derived entirely from the final fractionation step.

One option of the disclosed processes and apparatus offers the production of a substantially ash-free coke, suitable for manufacture of aluminum-smelting anodes. With this option, it is useful to input a substantially ash free feed to the delayed coker.

FIGS. 1 and 2 disclose processes for achieving substantially ash-free coke. Referring first to FIG. 1, the process entails the following:

(a) Dissolving the coal in a suitable solvent selected from or functionally equivalent to those on the list at the bottom of each figure and process-derived recycle solvent.

(b) Separating the solid/liquid slurry downstream of the dissolver step, thereby rejecting almost all the ash and some un-dissolved coal as a solid product.

(c) Feeding the liquid stream resulting from the ash separation step, which is a solution of coal-derived material in the solvent, to a flash step to substantially remove the solvent from the coal-derived material.

(d) Feeding the substantially ash and solvent-free material to the delayed coker.

(e) Distillate liquid products from the delayed coker are either utilized as a single liquid product or separated into typical refinery fuel fractions for further upgrading, usually by hydro-treating and/or hydrogenation.

(f) The solid coke product of delayed coking may then be utilized either as anode grade coke or may be further processed into activated carbon. Activated carbon may be utilized for typical applications such as absorption and purification and may also be used to capture environmentally undesirable heavy metals, such as mercury or arsenic, contained in coal or heavy oil burning power plant flue gases produced during the combustion of the fuel. Graphite is also a potential product of this process.

In anode production, the form of carbon itself is significant, with the anisotropic form of carbon being desired. To achieve this decant oil is a desirable petroleum derived stream.

In the variation illustrated in FIG. 2, the solvent flash is eliminated, resulting in a simplified process and a reduction in equipment, associated capital and a heat consuming step.

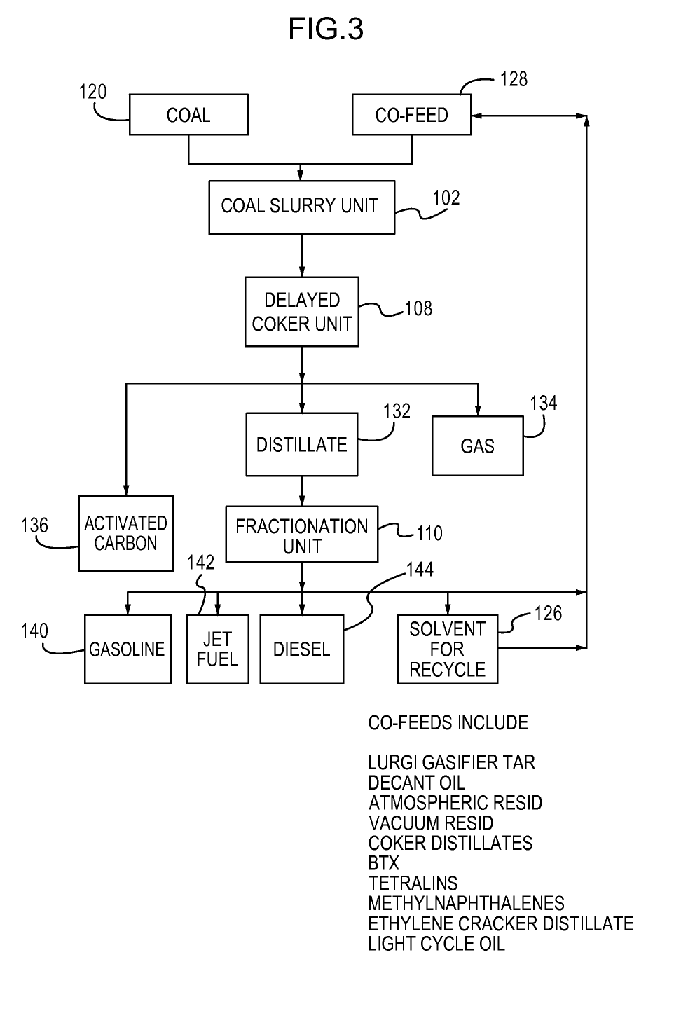

FIG. 3 illustrates a flow scheme suitable for production of activated carbon from coal which is suitable for reduction of heavy metals, such as mercury and arsenic in power plant flue gas. In power plant application integration of the activated carbon production process in to the power plant is desirable. In this application, within reason, the ash content of an activated carbon is not critical, particularly where a low cost product is required. In this application the level of ash rejection upstream of the coker is not critical and may be eliminated completely. In addition, the basic structure of the carbon need not be isotropic, which offers more latitude in the nature of the petroleum feed to the coker, which could quite be possibly a resid, and not the more expensive decant oil. Therefore, feeds to the delayed coker may include coal plus resid, a low value refinery product.

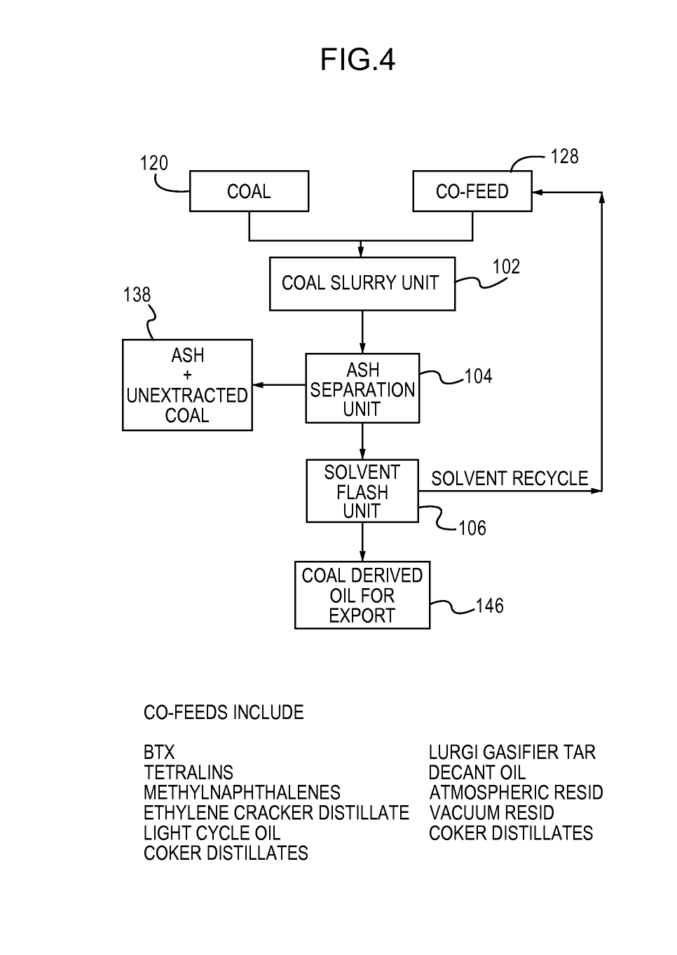

FIG. 4 discloses an example for production of a coal derived hydrocarbon product 146 suitable for exporting to existing petroleum refineries for upgrading into fuels, thereby supplementing the need for imported crude oil.

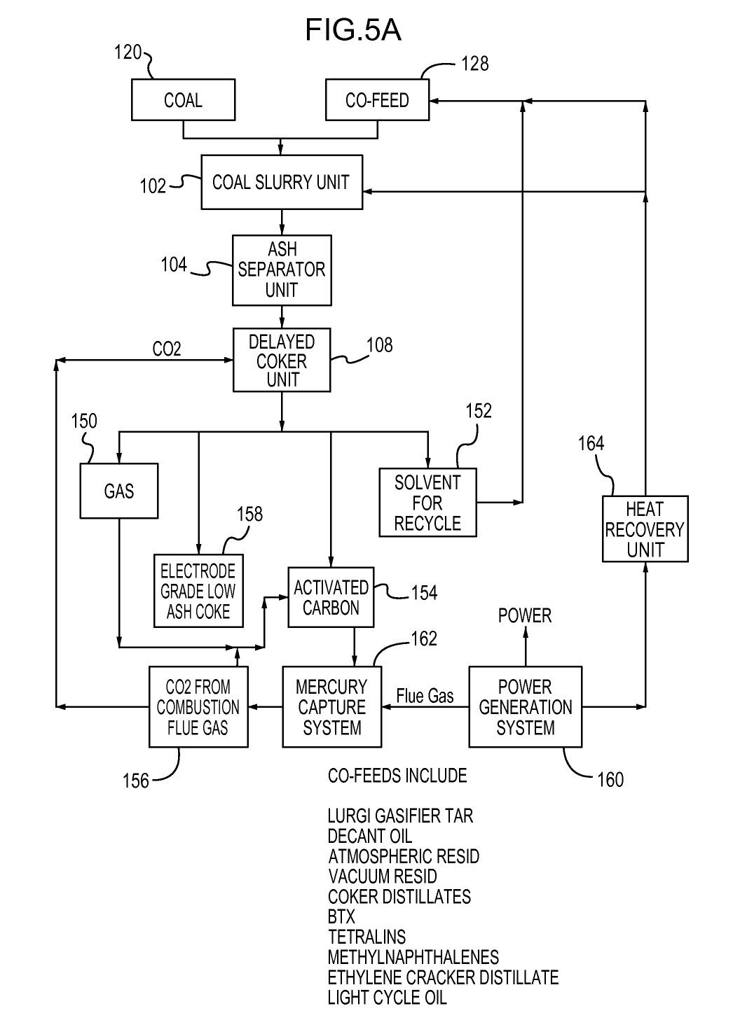

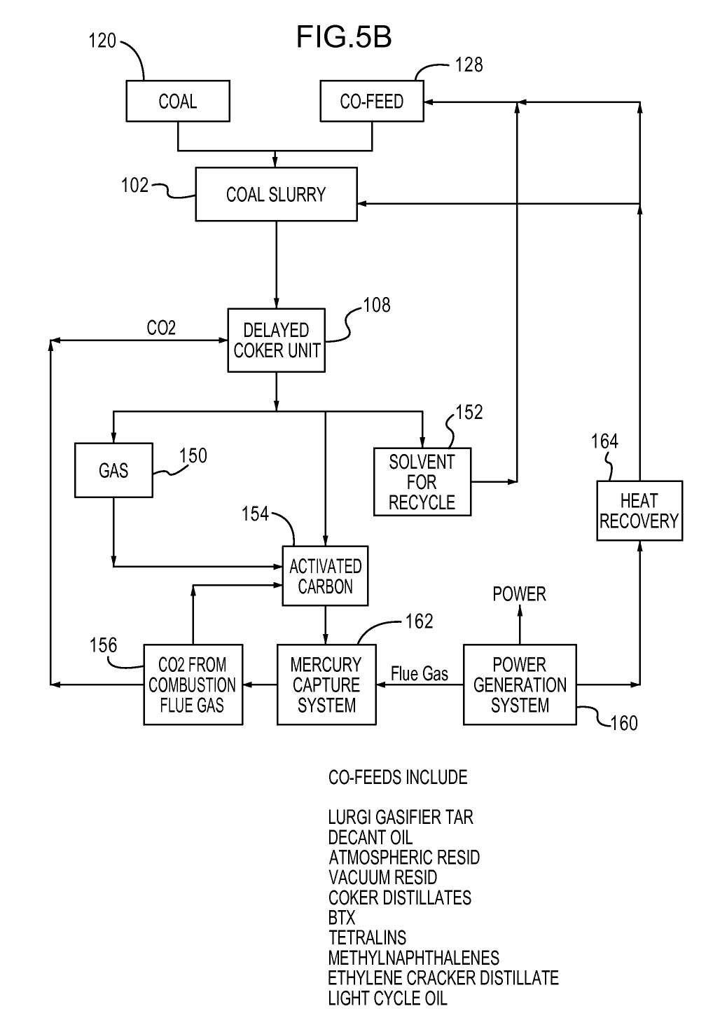

FIGS. 5A-B are schematic and flow diagrams illustrating integration of activated carbon production with power plant flue gas clean up.

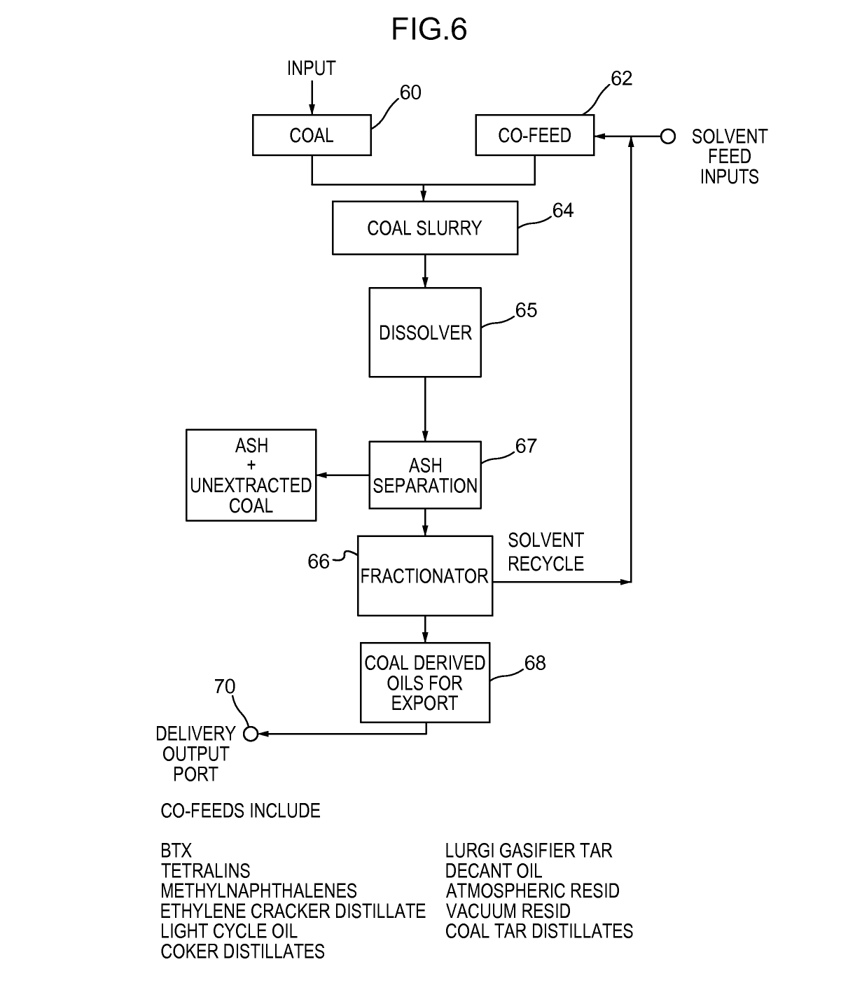

FIG. 6 is a schematic and flow diagram of apparatus and processes for production of coal derived oils.

Many of the functional components shown in FIG. 5 are similar to the corresponding components or functions of FIGS. 1-4. The intermediate products includes gas 150, solvent for recycle 152, activated carbon 154, CO2 from combustion flue gas 156 and electrode grade low ash coke 158. The illustrated operational components of the coal driven electric power plant generator include a conventional coal based power generation system 160 (with a coal feeder, not shown), as well as a mercury capture system 162. The activated carbon products 154 produced according to the described processes may be input to the mercury capture system 162 in order to further the reduction or elimination of undesirable emissions as described above. As also indicated, the CO2 from the combustion flue gas 156 may be fed back to the process (specifically, through the delayed coker unit 108) of producing the activated carbon. For improved efficiency in solvent extraction the heat recovery by the heat recovery unit 164 from the power generation system is intended to keep the coal slurry operating at a preferred operating temperature in the range of 200-400° Celsius. The input to coal-solvent slurry includes the coal, preferably crushed or pulverized, and the solvent preferably selected from the listing of solvents illustrated in FIGS. 1 and 4.

Referring to FIG. 5A, the coal-solvent slurry is heated to the preferred operation temperature as noted. After the coal-solvent slurry, which is activated by a power agitator, not shown, reaches the desired coal dissolved range of sixty to seventy percent of the coal charge, the ash separator removes ash and un-extracted coal. After this removal by the ash separator the mixture of un-dissolved coal and dissolved coal-solvent liquid is input to the delayed coker. The CO2 from combustion flue gas can be fed to the delayed coker, or alternatively, directly to the activated carbon unit. Where the flue gas is fed to the delayed coker, it may react therein as described, but even if the temperature is not sufficient to consume the CO2, the gas will pass to the activated carbon unit where the operating temperature is higher, to ensure a reaction that will consume the CO2. Output from the activated carbon production unit is transferred to the mercury capture system and the exhaust flue control solution to avoid exhaust of mercury from the exhaust flue of the electric power plant. Output from the delayed coker also results in electrode grade low ash coke, which for example, produces coke products for the manufacture of aluminum-smelting anodes for sale to the aluminum industry.

Mixing coal with a very heavy solvent, such as vacuum resid, coal tar pitch, or petroleum pitch, and then feeding this mixture into a fractionator or a coker/activation furnace with CO2 and/or steam could be a direct route to an activated carbon product with a reduced number of processing steps.

FIG. 5B illustrates a process wherein the ash separator is omitted. This results in a process that does not generally result in sufficient yield of electrode grade low ash coke, but does provide a more economical production of activated carbon usable for undesirable emissions reduction.

FIG. 6 discloses a process that begins by combining a pulverized coal from a coal bin with a coal solvent entered into a coal slurry from a solvent co-feed unit. As will be hereinafter further defined, the mixture of pulverized soft coal and the coal solvent selected to the list of solvents at the bottom of FIG. 6 are combined in the coal slurry bin in predetermined proportions. In addition to the specific examples described herein, those skilled in the art will readily recognize that, dependent upon various factors as hereinabove described, and depending on the grade of coal selected for the process and the types of end products to be manufactured, the predetermined proportions may readily vary.

The coal slurry is agitated in the coal slurry or coal dissolver at a temperature in the range of 200 to 500° centigrade. Further, the agitation of the coal slurry is generally continued until in the order of 60% to 70% by weight of the pulverized coal is dissolved.

After the coal slurry is appropriately dissolved, the remaining ash and any un-extracted coal is removed to produce a substantially ash-free coal slurry liquid. Thereafter the filtered substantially ash free coal slurry liquid is fed into a fractionator or delayed coker unit for further heat treatment process. Preferably at this step a portion of the coal solvent is recycled from the fractionator and is returned to the co-feed unit to be combined with additional pulverized coal input into the coal slurry unit to thereby continue the process. Preferably agitation of the coal slurry continues until in the order of 70% by weight of the pulverized coal is dissolved in the coal slurry or dissolver unit before the ash-free coal liquid is introduced into a fractionator unit 68 for further heat treatment. The output of the fractionator unit is fed to a final storage unit where the produced coal derived oils are stored for export or transfer to a user in other manufacturing processes.

Referring again to FIG. 6, an apparatus for production of coal derived oils is also illustrated and described. An input coal receptacle 60 is prepared to receive pulverized coal and a coal solvent co-feeder 62 is arranged to receive a coal solvent with the pulverized coal and coal solvent being loaded in predetermined proportions in accordance with the parameters of the predetermined desired end product. The respective outputs of the pulverized coal container 60 and the coal solvent co-feeder 62 are fed into the coal slurry agitator 64. The dissolver 65 has an operating pressure in the range of 100 to 3000° psig and is arranged to receive the output of the coal slurry agitator 64 which preferably is driven or cycled until in the order of 70% by weight of the pulverized coal has been dissolved. Preferably, the ash-free slurry is agitated at a temperature in a range of 200 to 400 or up to 800 degrees centigrade for certain end products. An ash separation unit 67 accepts the output of the dissolver unit 65 and feeds fractionators 66 to further heat treat the ash-free coal slurry in a plurality of temperature ranges depending upon the specific types of products to be manufactured. For example, a typical fractionator 66 usually handles several boiling range products, for example: a gasoline fraction in the range of 100 to 425° centigrade; a coal based oil fractionators in a range of 425 to 800° centigrade, and another coal based product above 800° centigrade. As will be known to those skilled in the coal based oil technologies, a much simpler solvent flash unit (not illustrated) could be utilized to replace the more expensive fractionator unit 66 to accommodate certain lower end products.

As illustrated in FIG. 6, a solvent recycle line connects an output of the fractionator unit 66 (or lower cost flash unit) and is coupled to the input of co-feed 62 to recycle recovered coal solvent to continue operation of the described process or production apparatus. The output of the fractionator 66 is fed to the input of reservoir 68 for storing the produced coal derived oils for export to other commercial users via output delivery port 70.

Referring again to the list of alternative coal solvents at the lower end of FIG. 6, those skilled in coal derived oils technology will be familiar with the listed or similar alternative coal solvents for use in the disclosed and alternative embodiments.

One specific example of the process and corresponding apparatus is set forth in the steps below:

Step 1—Fill the coal-solvent slurry at a preferred ratio of 10:1 by weight of coal to a light cycle oil or alternate solvents from the list on FIGS. 1-4 and FIG. 6;

Step 2—Agitate the coal solvent slurry in the mixing unit until in the order of 60% to 70% of the coal slurry has been dissolved at the preferred operating temperature in the order of 350 degrees C. or higher for specific end products;
Step 3—Separate any coal ash from un-dissolved coal and the dissolved coal-solvent liquid in a separator unit;
Step 4—Feed the output of the separator unit which comprises approximately 30% un-dissolved coal and 70% dissolved coal and solvent liquid into fractionator or a delayed coker;
Step 5—Feed the output of the fractionator or alternatively a delayed coker unit to several electable separate processing units in predetermined portions: a coker to produce very low ash coke for manufacturing aluminum-smelting anodes, a process unit for combining carbon dioxide with the output of the delayed coker to produce activated carbon products, and diverting a desired portion of the dissolved coal-solvent liquid or recycling to the solvent extraction unit or for further distillate refinery processing.

As further illustrated in FIG. 6, the output from the fractionator of coal derived oils is coupled to a storage unit or to an output delivery port or tank 70.

The forgoing description of the various embodiments of producing coal derived oils have been provided for purposes of illustration only and numerous changes may be made without departing from the spirit and scope of the disclosed and claimed embodiments of the invention. For this reason reference should be had solely to the appended claims for determining the scope of the present invention.

What is claimed is:

1. A process for production of coal derived oils comprising the steps of:
producing a coal slurry liquid by mixing pulverized coal and a coal solvent in predetermined proportions in an agitation container unit;
applying ash separation to the coal slurry to remove ash and un-extracted coal to produce a substantially ash-free coal slurry liquid;
introducing the ash-free coal slurry liquid into a fractionator unit;
recovering recycled solvent for introduction to a co-feed unit; and
recovering coal derived oils from the fractionator unit.

2. The process of claim 1 wherein the ash-free slurry is agitated at a temperature in the range of 200 to 550° centigrade.

3. The process of claim 1, wherein the coal slurry is agitated until approximately 60% to 70% by weight of the pulverized coal is dissolved.

4. The process of claim 1, wherein the solvent is selected as a means of reducing sulfur from the coal slurry in the fractionator unit.

5. A process for producing coal derived oils comprising the steps of:
producing a coal slurry by mixing pulverized coal and a coal solvent in predetermined proportions in an agitator unit;
removing ash and un-extracted coal from the agitators unit to produce a substantially ash-free coal slurry liquid;
introducing the substantially ash-free coal slurry into a fractionator or a delayed coker; and
recovering solvent from the fractionator or delayed coker output for production of coal derived oils.

6. An apparatus for producing coal derived oils comprising:
a coal receptacle;
a solvent feed and recycle unit;
a coal slurry unit;
a coal slurry dissolver unit;
an ash and un-extracted coal separator unit;
a fractionator unit fed from the separation unit;
a recycle unit for recycling a portion of solvent from the fractionator unit to the co-feed unit; and
an output unit for collecting coal derived oils.

7. The apparatus of claim 6, wherein the fractionator operates for coal derived oil in the temperature range in order of 425 to 800° centigrade.

8. The apparatus of claim 6 wherein the functions of the coal slurry unit and the coal slurry dissolver unit are functionally combined.

9. The apparatus of claim 6, wherein the coal solvents comprise one or more of BTX, tetralins, methylnapthalenes ethylene cracker distillate, light cycle oil, coker distillates, lurgi gasifier tar, decant oil, atmospheric resid, vacuum resid, or coal tar distillates.

10. The apparatus of claim 6, wherein the coal solvents comprise BTX, light cycle oil, decant oil or coal derived distillates.

11. The process of claim 1, wherein the coal solvent comprises one or more of BTX, tetralins, methylnapthalenes ethylene cracker distillate, light cycle oil, coker distillates, lurgi gasifier tar, decant oil, atmospheric resid, vacuum resid, or coal tar distillates.

12. The processes of claim 1, wherein the coal solvent comprises BTX, light cycle oil, decant oil or coal derived distillates.
